(19) United States
(12) Patent Application Publication
(10) Pub. No.: US 2024/0054204 A1
(43) Pub. Date: Feb. 15, 2024

(54) DIGITAL ID STORAGE AND FEDERATION SERVICE MODEL

(71) Applicants: UNIVERSITY-INDUSTRY FOUNDATION OF SEOUL UNIVERSITY OF FOREIGN STUDIES, Seoul (KR); SOONCHUNHYANG UNIVERSITY INDUSTRY ACADEMY COOPERATION FOUNDATION, Chungchengnam-do (KR)

(72) Inventors: Keun Dug PARK, Seoul (KR); Heung Youl YOUM, Seoul (KR)

(21) Appl. No.: 18/253,424

(22) PCT Filed: Nov. 23, 2020
(86) PCT No.: PCT/KR2020/016584

§ 371 Date: May 18, 2023

(30) Foreign Application Priority Data
Nov. 20, 2020 (KR) 10-2020-0156205

(51) Int. Cl. G06F 21/34

(52) U.S. Cl. CPC G06F 21/34

(57) ABSTRACT

A digital ID storage and federation service model is disclosed. In the digital ID storage and federation service model according to the present invention, the custodian creates a federation ID (F-ID) mapped to a digital ID received from the issuer, delivers it to the holder, and stores it in a ledger for ID sharing. When the holder submits the F-ID to a service provider while requesting the service from the service provider, the service provider requests verification from the custodian, and when all ID transaction event history is recorded in a ledger for ID transaction, the custodian delivers that verification is normally completed to the service provider, and the service provider provides the requested service to the holder.

### TECHNICAL FIELD

The present invention relates to a digital ID service model, and more specifically, to a digital ID storage and federation service model which safely entrusts a custodian, who is a third party, with a digital ID and has a federation function capable of being interlocked even when digital ID services different from each other are created.

### BACKGROUND ART

Traditionally, people needed a means to prove “who I am” in order to engage in social and economic activities.

Since the advent of the Internet, as digital IDs (e.g., decentralized IDs, private certificates, public certificates, etc.) have been used in the digital age, many methods have been attempted to prove oneself.

Representative methods for authenticating a person include knowledge-based, possession-based, and biometric-based methods. In Korea, a public key infrastructure (PKI)-based authentication method using an authorized certificate or a private certificate issued by a third trusted institution has been widely used in order to use important services such as financial and public services.

However, procedures for managing public certificates or private certificates, such as issuance and renewal, are complicated and inconvenient.

In addition, in order to receive services, companies or institutions must agree to the right to collect and use additional personal information, and despite the level of assurance required for each type of service being different, excessive information is provided, thereby losing control over user's personal information.

To make matters worse, if the institution or company that stores personal information fails to safely manage it due to negligence, intention, or error, the primary damage from leakage of personal information will be the responsibility of the individual.

In order to improve these problems, various studies have been conducted centering on the W3C since Christopher Allen mentioned the concept of Self Sovereign Identity in 2016.

The Self Sovereign Identity is a concept in which users themselves manage and control identity verification information beyond user-centered identity verification. Recently, by incorporating distributed ledger technology (DLT), a decentralized identity (ID) model that can issue and verify identity based on trust have been developed, and research is actively conducted to apply it to various service cases.

Here, the decentralized ID means a decentralized digital identity verification system in which the holder can guarantee self-sovereignty through management of identity information, control of the scope of submission and subject control, etc. in the digital environment.

The problem with the digital authentication transaction model through decentralized ID that has been discussed so far is that it cannot escape the limits of mobile security threats because it is a method of storing identity information and private keys in the user's mobile device.

In addition, the issue of interlocking between heterogeneous decentralized IDs remains an issue that needs to be addressed at some point.

### SUMMARY OF INVENTION

### Technical Problem

The present invention is to solve these problems, and an object of the present invention is to provide a digital ID storage and federation service model that can improve problems caused by loss and theft of mobile devices storing identity information and limitations of the mobile device itself.

In addition, another object of the present invention provides a digital ID storage and federation service model in which a custodian receives and safely stores identity information issued by a holder from an issuer and an auditor monitors ID transactions.

In addition, another object of the present invention is to provide a digital ID storage and federation service model to which a distributed ledger technology-based system such as Ledger for ID sharing and Ledger for ID transaction is added.

In addition, another object of the present invention is to provide a digital ID storage and federation service model in which the role of verification and service provision performed by a verifier is divided into a verifying agency and a service provider.

In addition, another object of the present invention is to provide a digital ID storage and federation service model that enables ID federation between domains by building a ledger for ID sharing with distributed ledger technology of a common protocol so that only custodians belonging to each domain can access it.

### Solution to Problem

To achieve the objects, according to the present invention, there is provided a digital ID storage and federation service model in which a custodian receives and safely stores identity information issued by a holder from an issuer and an auditor monitors ID transactions, wherein the custodian creates a federation ID (F-ID) mapped to a digital ID received from the issuer, delivers it to the holder and stores it in a ledger for ID sharing at the same time, and records all ID transaction event history in a ledger for ID transaction, and wherein when the holder submits the F-ID to a service provider while requesting the service from the service provider, the service provider requests verification from the custodian, and when the custodian delivers that the verification is normally completed to the service provider, the service provider provides the requested service to the holder.

In addition, when the service provider requests verification, the custodian requests approval for verification from the holder, and then performs a verification work only when there is approval of the holder. In the identify verification work, a verifying agency who acts as an agency for a digital ID verification work of the holder is requested for verification in response to the request of the custodian, and the requested verifying agency requests a verification work to be performed in a verification data registry in which a certificate of an issuer for the digital ID is registered, and receives the performed verification result.

In addition, the digital ID storage and federation service model may further include an auditor including a business operator or an institution that performs policy management, monitoring, and auditing of digital ID storage and transaction, wherein the auditor may detect and monitor abnormal transaction on all work history of transacting digital IDs for operating an abnormal transaction detection system.

In addition, the custodian may include individual custodians belonging to each domain, and a ledger for ID sharing may be built with distributed ledger technology of common protocol to which the individual custodians are accessible, to operate to enable ID federation between domains.

### Advantageous Effects of Invention

According to the digital ID storage and federation service model according to an embodiment of the present invention, by adding a separate safe custodian and auditor, the holder can use the digital ID more safely and conveniently while ensuring self-sovereignty over the data, and it is possible to enhance the security of the custodian system and to enhance monitoring and surveillance through the auditor.

In addition, according to a digital ID storage and federation service model according to another embodiment of the present invention, it is necessary to configure a complicated procedure in which all federations must be configured for each domain when IDs between domains federate without a ledger for ID sharing, but in the present invention, this problem can be solved because IDs between domains can federate through the ledger for ID sharing. In addition, as the number of domains that can federate increases, the holders can conveniently enjoy a wide range of services.

### BRIEF DESCRIPTION OF DRAWINGS

FIG. 1 is a schematic diagram of a conventional DID model of W3C.

FIG. 2 is a schematic diagram of a conventional decentralized ID model of SOVRIN.

FIG. 3 is a diagram illustrating service configuration using a decentralized ID by Military Manpower Administration and Ministry of Patriots and Veterans Affairs in conjunction.

FIG. 4 is a schematic diagram illustrating a basic model of decentralized ID.

FIG. 5 is a diagram for explaining an operation method of a main composition of a digital ID storage and federation service model according to an embodiment of the present invention.

FIG. 6 is a diagram illustrating an example of a service model providing federation between domains according to another embodiment of the present invention.

### DESCRIPTION OF EMBODIMENTS

The terms or words used in this specification and claims are not limited to the usual or dictionary meaning, and it should be interpreted as meaning and concept consistent with the technical spirit of the present invention based on the principle that the inventor can appropriately define the concept of the term in order to explain his or her invention in the best way.

Throughout the specification, when a certain component is said to “include” other components, it means that it may further include other components and not exclude other components unless otherwise stated. In addition, terms such as “ . . . portion”, “ . . . unit”, “module”, and “device” described in the specification mean a unit that processes at least one function or operation, and can be implemented as a combination of hardware and/or software.

Throughout the specification, the term “and/or” should be understood to include all possible combinations from one or more related items. For example, “first item, second item and/or third item” means a combination of all items that can be presented from two or more of the first, second or third items, as well as the first, second or third item.

Hereinafter, an embodiment of the present invention will be described with reference to the accompanying drawings.

First, domestic and international research trends related to decentralized ID and their common models will be described, and more specifically, the limitations of the existing decentralized ID service model will be described, thereby disclosing the improved digital ID storage and federation service model of the present invention that solves the problems of the existing model and identifying the security requirements of the improved model and the expected effect thereof.

In addition, the direction of development of the present invention in the future will be partially described.

First, looking at overseas decentralized ID research, decentralized ID technology using distributed ledger technology is still in an incomplete state, but it is expected to develop rapidly as many global companies participate in technology development and standardization. Accordingly, places where several companies or institutions, not specific companies or institutions, are conducting joint research in alliance will be introduced.

Representative overseas companies and institutions working together on decentralized ID are W3C (World Wide Web Consortium), DIF (Decentralized Identity Foundation), and SOVRIN Foundation.

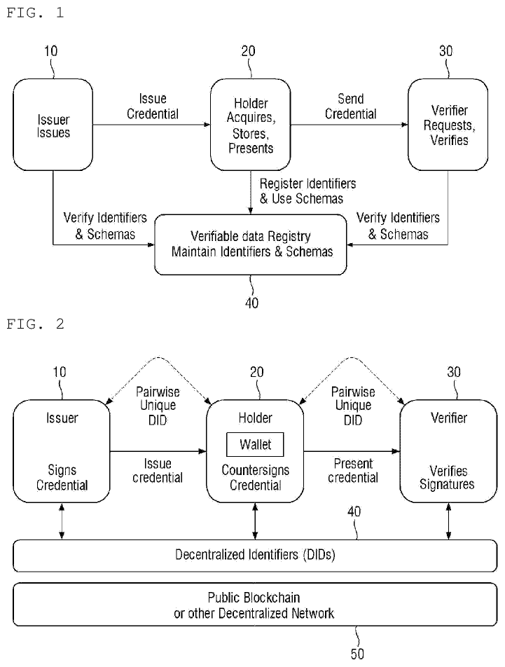

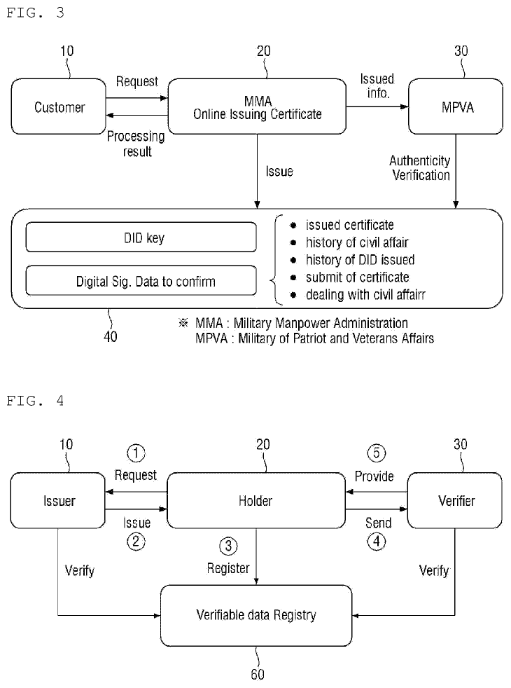

First, W3C, established in 1994, is an organization that promotes web-based technology standardization. As illustrated in a schematic diagram of a conventional DID model of W3C in FIG. 1 and a schematic diagram of a decentralized ID model of SOVRIN in FIG. 2, roles of issuer 10, holder 20, and verifier 30 configuring the decentralized ID, and information such as verifiable credential (VC), decentralized identifier (DID) 40, and DID document are standardized.

The W3C defines a decentralized ID (DID) as a decentralized identifier (DID) 40 and not a decentralized identity, and describes it as a text string similar to UUID (universally unique identifier) specified in RFC4122.

The decentralized ID service model of W3C is a certificated-based model, in which an identify certificate including personal information is issued, a holder stores and manages it in an electronic wallet, and a user directly submits as necessary.

In this case, the distributed ledger technology servers as a decentralized identifier registry (DID registry) and supports verification of an identify certificate.

DIF established in 2017 is a standard technology development organization created by about 80 companies including Microsoft, IBM, and Master Card to build a decentralized ID ecosystem, and is an engineering-based organization that develops interconnection and federation technologies among all participants to build an open ecosystem.

A DIF working group designs and implements specifications, standards, and libraries related to decentralized ID-based authentication (DIDauth), implements specifications for authenticated message-based communication (DIDComm), and donates them as open sources.

Decentralized ID base technology is being standardized around W3C and DIF.

The SOVRIN Foundation, established in 2016, is a non-profit organization in which companies or individuals from each country participate. As the most active organization in the formation of a decentralized ID federation ecosystem, it has built a blockchain network exclusively for decentralized ID and started commercial services.

As illustrated in FIG. 2, the difference between the SOVRIN Foundation and the W3C is that it uses a unique decentralized ID among the issuer 10, the holder 20, and the verifier 30 in the verifiable identity verification process.

Evernym, a British startup company belonging to the SOVRIN Foundation, participated in the development of Hyperledger Indy, a blockchain platform dedicated to decentralized ID, and donated it as an open source for free.

Next, in the direction of domestic decentralized ID research, various organizations form forces in the form of a consortium or alliance to create a decentralized ID application ecosystem and focus on discovering services that can be applied in practice.

In addition, although the standards of the W3C are applied in common, the technical standards are developed slightly differently in different associations.

In order to solve these problems, the Korea Internet & Security Agency and the Financial Security Institute prepared guidelines for the expansion of the decentralized ID ecosystem in the future, and signed a business agreement for the promotion of decentralized ID-related policy/technology research and standardization.

Representative places that are creating a decentralized ID ecosystem in Korea are Initial DID Association, DID Alliance Korea, and MyID Alliance.

First of all, the Initial DID Association, established in 2019, currently has 14 companies participating in the consortium, including three domestic telecommunications companies, five major banks, two credit card companies, IT companies, and Samsung Electronics.

With the ‘2019 Blockchain Private Led Public Project’ hosted by the Ministry of Science and ICT and the Korea Internet & Security Agency, a consortium formed around SKT is promoting a mobile electronic certification pilot service that can be used conveniently and safely by the public.

The initial DID association is based on Hyperledger Fabric, and consortium participants are supposed to participate as peer operators. The association is developing an identity certificate-based service by applying the W3C standard technology, and the open source of Hyperledger Indy is used for the electronic wallet and SDK.

A mobile app called Initial, which will be launched in early 2020, allows a holder to store and control their identity certificates.

DID Alliance Korea is an alliance composed of 56 domestic and foreign companies centering on RaonSecure in July 2019 along with the Korea Financial Telecommunications and Clearings Institute, and is actively researching global technology standards and business models. Recently, the global DID Alliance was established in the United States to expand its influence as an international corporate alliance. With the development of Infowallet, a blockchain-based personal information service, RaonSecure, which leads the DID Alliance, basically provides FIDO biometric authentication and identity verification services through OmniOne, an EOS-based decentralized ID platform.

In fact, RaonSecure participated in the ‘2019 Blockchain Public Pilot Project’ hosted by the Ministry of Science and ICT and the Korea Internet Promotion Agency with the OmniOne platform, and applied a simple authentication service using decentralized ID to the newly built Civil Service portal site of the Military Manpower Administration. Referring to the service configuration diagram using decentralized ID in connection with the Military Manpower Administration and the Ministry of Patriots and Veterans Affairs in FIG. 3, it is possible to easily log in and verify identity by replacing the public certificate with decentralized ID by installing a simple authentication mobile app. After the simple authentication service, support is planned to be expanded to the issuance of medical certificates.

The Korea FIDO Industry Forum and Ramesh Kesanupalli, founder of the FIDO Alliance, are participating and actively utilizing FIDO biometric authentication technology.

And MyID Alliance, which was launched in November 2019, consists of 52 companies in the financial or non-financial sector, centered on ICONLOOP, a domestic distributed ledger technology solution company.

MyID platform of ICONLOOP has been designated as a financial regulatory sandbox for innovative financial services by the Financial Services Commission for non-face-to-face authentication services when opening a bank account.

In addition, through a mobile app with identity verification and cryptocurrency e-wallet functions using distributed ledger technology called DPASS (Decentralized Passport), the holder can safely manage and use their personal information. DPASS also applies W3C's decentralized ID standard system, so the possibility of service expansion is high.

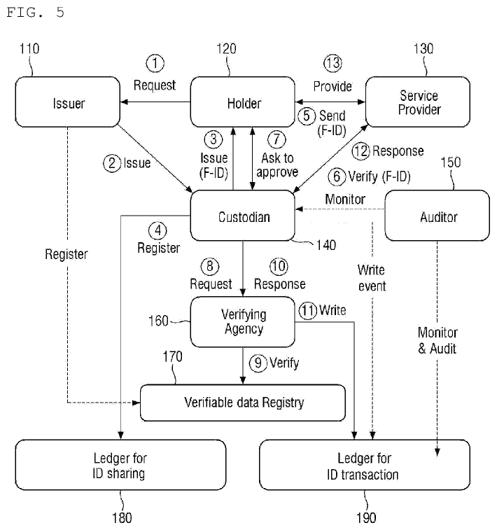

These current decentralized ID technology standards have been mainly developed by W3C or DIF, and domestic and foreign decentralized ID service models are configured in the same form as the basic model diagram of decentralized ID in FIG. 4.

The basic configuration is configured so that the holder 20 receives and submits identity information, which is necessary for receiving desired services from the verifier 30, from the issuer 10.

In this case, to ensure the validity of the identity information issued by the issuer, the certificate of the issuer 10 is stored in a verifiable data registry 60, which is a reliable registry.

The verifier that receives the identity information verifies its validity in the verifiable data registry 60 and provides the service.

Here, the issuer 10 has the identity information of the holder 20, and operates to deliver a certificate together so that information issued to a business operator or institution that issues a decentralized ID is reliable, in response to the request of the holder 20.

The holder 20 is a user who wants to prove his or her identity by using a decentralized ID, and corresponds to a mobile device of a user who receives and submits a decentralized ID in the system configuration.

The verifier 30 verifies through the verification data registry that the identity information issued by the issuer 10 to a business operator or institution providing services after confirming the identity with the decentralized ID at the request of the holder 20 is valid identity information.

The verification data registry 60 means a distributed ledger-based trusted registry in which the identifier of the holder 20, the certificate of the issuer 10, identity verification cancellation history, and identity verification schema are registered.

This existing decentralized ID service model has the following limitations.

The problem with the existing model is classified into a problem of user information protection caused by the holder 20 using a mobile device, a problem of user's convenience deterioration, and a problem related to interoperability of decentralized ID systems built independently due to insufficient development of common technical standards.

First, as for the information protection problem of the holder (user), the decentralized ID service model currently being developed by various associations allows the holder to store user's identity information in a mobile device. Security threats in the environment using mobile devices can be divided into the areas of devices, networks, platforms, and applications.

Among them, the threats to the mobile device itself correspond to malware infection in the device area, loss and theft, and data exposure. Due to the security threats of the mobile device itself, the following limitations exist due to hacking and loss (theft).

Although it may be different depending on the individual's security level, most mobile users are unfamiliar with security. Accordingly, in an environment where decentralized ID and private key leakage (CT1; Data leakage from hacking) due to malware or hacking in vulnerable mobile devices and annual average loss of more than 1 million smartphones occur, decentralized ID and private key leakage (CT2; Data leakage from loss) due to the loss (theft) of users' mobile devices is a problem.

Next, in terms of holder (user) convenience, since most people are mobile device users due to the popularization of mobile devices, even in the decentralized ID service model, mobile devices are being utilized so that the decentralized ID can be issued more conveniently and submitted at the discretion of the holder.

However, when the mobile device is sometimes left behind or lost, the following inconveniences exist due to limitations of the mobile device.

At the time of using a decentralized ID service using a limited terminal called a mobile device, there are inconvenience (CT3; Limited terminal (mobile)) that occurs when a mobile device is not at hand and inconvenience (CT4; Revocation and Reissue since loss) of having to revoke and reissue as many IDs as the number of IDs issued by the issuer when a user loses or replaces a mobile device, in the worst case, when the decentralized ID and private key are leaked.

Describing interoperability, as described above, the three domestic decentralized ID associations also refer to the standards of DIF or W3C, but the standards are not at a level that can be applied to all services, and there is no compatibility between each decentralized ID.

In the case of Korea, standardization work is also sluggish, so it is pointed out that technology standardization is urgently needed above all else. In a situation where there is no common technical standard or is not detailed, each company or alliance applies its own technology and develops it little by little when it is actually applied to the service, so it is inevitable to build a different decentralized ID platform. In the worst case, a problem may arise in which a mobile ID is issued differently for each service, making the holder very inconvenient.

Therefore, there is an interoperability problem (CT5; Interoperability) of decentralized ID service platforms that may occur in the future due to different implementations for each company or association with decentralized ID technology.

Accordingly, one feature of the present invention is to provide a “digital ID storage and federation service model” that can store identity information stored in a mobile device of a holder and improve problems caused by loss and theft of the mobile device and limitations of the mobile device itself.

In addition, the present invention can improve both the existing PKI-based authentication system and decentralized ID system, and can solve compatibility issues between various federations that develop decentralized ID service models or federation issues of decentralized ID systems independently built in various domains.

Specifically, the digital ID storage and federation service model according to an embodiment of the present invention is a kind of consignment agency service that allows the custodian to safely store identity information issued by the issuer to the holder and use it for ID transactions.

The difference between the digital ID storage and federation service model of the present invention and the components of the existing model can be summarized in the following three points.

First, a custodian and an auditor are added to the service model, second, a system based on distributed ledger technology such as ledger for ID sharing and ledger for ID transaction is added, and third, the role of verification and service provision performed by the verifier is divided into a verifying agency and a service provider.

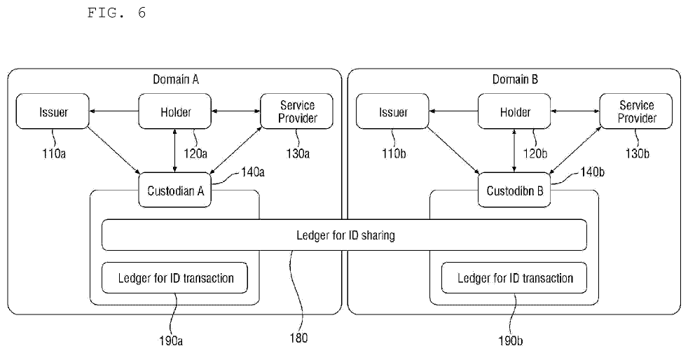

Referring to the main configuration diagram of the digital ID storage and federation service model according to an embodiment of the present invention in FIG. 5 (configurations overlapping with existing model components are indicated by different reference numerals and detailed descriptions are excluded), first, a custodian 140 means a business operator or institution that safely stores the digital ID issued by an issuer 110 and records all ID transactions.

An auditor 150 means a business or organization that performs policy management, monitoring, and auditing of digital ID storage and transactions, and a service provider 130 means a business operator or institution that plays a role of providing a service when a digital ID is submitted from a holder 120 and the identity of the holder is confirmed among the roles of the verification institution of the basic model.

A verifying agency 160 is a business operator or organization that verifies the digital ID of a holder among the roles of a verification agency in the existing model and means an institution that acts as an agency for verification work at the request of the custodian, and of course, the custodian may also serve as a verifying agency.

A ledger for ID sharing 180 means a distributed shared ledger that stores an F-ID mapped to a digital ID of a holder 120 issued by an issuer 110, and a ledger for ID transaction 190 means a distributed shared ledger that records and stores all work details that occur during decentralized ID transactions.

The ID transaction used in the present invention is a series of actions performed between the custodian 140 and other entities to prove the identity of the holder 120, such as issuance, registration, use, inquiry, renewal, and disposal of digital IDs.

In addition, F-ID (Federation-ID) is a certificate issued by the custodian 140 to the holder 120 for the purpose of ID transaction, and is mapped to a digital ID issued by the issuer 110.

The service function for storage and federation is also important to the custodian added in the present invention, but security for ID transaction is judged to be the most important factor. Accordingly, referring to the existing distributed ledger technology system or distributed ledger-based digital asset trading system, it can be identified as follows.

ID Leakage (ST1): The digital ID of the holder stored by the custodian may be leaked by external hacking.

Unauthorized use of ID (ST2): The digital ID of the holder can be stolen without permission by an insider of the custodian.

Forgery and falsification of ID transaction details (ST3): The custodian can forge and falsify the transaction details of the digital ID. In the proposed model, all event history related to ID transactions is subject to monitoring and audit by the auditor, so in the event of ID leakage or unauthorized use, the records may be damaged.

Encryption key leakage (ST4): The encryption key generated by the custodian to securely trade and store the digital ID may be leaked to the outside. When the encryption key used for digital signature and important data encryption is leaked, it may expand to secondary damage.

Application forgery and falsification (ST5): Information recorded in the distributed ledger is difficult to forge and falsify, but when the system that processes information before or the application in each node is maliciously changed or infected with malicious code, service may be delayed or stopped.

Unauthorized access (ST6): When unauthorized access is allowed to the distributed ledger or ID storage and transaction system operated by the custodian, service interruption and loss of users may occur.

The security requirements for the custody service model in which the custodian of the present invention is added are based on the contents described in the Information and Communication Organization Standard (standard number: TTAK.KO-12.0352) [24] ‘Security requirements for digital asset transaction service model based on distributed ledger technology’.

The security requirements for the custodian of the present invention include 8 kinds of user identification and authentication, network separation, malicious code control, data encryption, data integrity, generation and use of encryption keys, log recording and preservation, and operation of an abnormal transaction detection system.

Among them, the user identification and authentication items are the domain of the holder, which authenticates the user on the mobile app or web, and must perform the identity verification procedure before issuing identity information from the issuer.

Here, the security requirements for custodian and auditor, which are different from the existing model, will be described.

First, regarding network separation, a custodian should strengthen access control by physically or logically separating networks to prevent leakage of important assets (digital IDs, cryptographic keys, ledgers for ID sharing, ledgers for ID transaction, etc.) due to malicious attacks.

It is preferable for an ID transaction system, a cryptographic key management system, a ledger for ID transaction, a ledger for ID sharing, an ID storage system, a digital ID transaction fraud detection system, a developer, an operator, etc. to physically or logically separate the network, and to block unauthorized access through an access control system (e.g., firewall, network access control, server access control, DB access control, etc.).

The custodian 140 should establish and implement protection measures to prevent forgery, falsification and leakage of important assets (digital ID, encryption key, ledger for ID sharing, ledger for ID transaction, etc.) due to infection with malicious code.

In addition, when the custodian 140 stores the digital ID in the ID storage system, it should be encrypted with a secure algorithm.

In addition, transmission section encryption (e.g., TLS) should be applied to the section where the custodian communicates with an external network.

In addition, the custodian 140 should record the stored digital ID and all events occurring during digital ID transactions and prevent forgery and falsification. To this end, the custodian 140 needs to record and manage ID transaction details in the distributed ledger while operating a node based on a permissioned distributed ledger network.

In addition, the custodian 140 should manage the encryption key for encrypting and decrypting the digital ID and record and store the history in the process of issuing, submitting, storing, and linking the digital ID.

The custodian 140 should generate an encryption key for each holder from the encryption key management system (CKMS) and encrypt and decrypt digital IDs for each individual in the ID storage system, and it should be signed and verified with a PKI-based asymmetric encryption key when exchanging information with other entities other than the custodian.

Here, since the security of the cryptographic key management system is directly related to the security performance of the connected HSM (Hardware Security Module), it is desirable to use dedicated equipment of Level 4 grade [25] as defined by NIST FIPS 140-2.

In addition, the custodian 140 should record digital ID transaction details and preserve them for a certain period of time for log recording and preservation.

The custodian 140 operates the node of the ledger for ID transaction based on the permissioned distributed ledger, and the issuer, verifying agency, and an auditor also participate in node operation to ensure reliability.

Ledger data may include timestamps, transaction entities, transaction types, and whether or not they failed.

The most important thing in log record is the timestamp, so time synchronization of all systems should be a prerequisite.

All recorded timestamps are verified based on the timestamp entered in the hash process in which the block of the ledger for ID transaction is created.

The auditor 150 should be able to detect and monitor abnormal transactions for all work history of digital ID transactions in order to operate the abnormal transaction detection system, and prevent abnormal transactions and fraudulent use through real-time monitoring and periodic audits through the system.

An operation method of the digital ID storage and federation service model according to the present invention using the above-described configuration will be described with reference to FIG. 5.

FIG. 5 is a diagram for explaining an operation method of a main configuration diagram of the digital ID storage and federation service model according to an embodiment of the present invention. First, when the holder 120 requests identity information from the issuer 110 (Step 1), the issuer 110 and the holder 120 deliver identity information (e.g., an identity certificate, a private key, etc.) to the custodian 140, and the custodian 140 safely stores it (Step 2).

The custodian 140 issues a kind of certificate called F-ID (Federation ID) instead of the actual identity information of the holder 120 and delivers it to the holder 120 (Step 3), and simultaneously, the issued F-ID is recorded in the ledger for ID sharing 180 (Step 4).

After the F-ID is recorded in the ledger for ID sharing 180 in Step 4, when the holder 120 requests a service, the F-ID is submitted to the service provider 130 (Step 5).

Step 5 is to proceed with the identity verification step as in the case where the holder (user) requests Internet banking service.

In this case, the service provider 130 requests verification of the F-ID received from the holder 120 to the custodian 140 who issued the F-ID (Step 6).

In this case, the custodian 140 must request the holder 120 for approval for verification, and starts the verification work only when the holder 120 approves (Step 7).

By doing so, the holder 120 can realize self sovereign identity (SSI).

In the identity verification work, the custodian 140 requests verification to the verifying agency 160 (Step 8), and the verifying agency 160 performs the verification work through the verifiable data registry 170 (Step 9).

The verification result verified in Step 9 is delivered to the custodian 140 (Step 10).

In this case, in order for the verifying agency 160 to perform verification work on the digital ID issued by the issuer 110, the certificate of the issuer 110 should be registered in the verification data registry 170 in advance.

All ID transaction event details of the verifying agency 160 or the custodian 140 are recorded in the ledger for ID transaction 190 (Step 11).

When the verification work is completed, the custodian 140 transmits to the service provider 130 that the verification has been successfully completed (Step 12), and the service provider 130 provides the service requested by the holder 120 (Step 13).

Finally, the auditor 150 operates to perform constant monitoring and regular audit so that the custodian 140 or the verifying agency 160 properly performs its function and role.

Meanwhile, when the existing decentralized ID service model is actually applied to business, the probability of using an integrated decentralized ID platform by achieving social consensus in various fields is very slim.

Even when decentralized ID service models are built differently across multiple domains, another feature of the newly proposed digital ID storage and federation service model of the present invention is that it can be extended to a service model in which custodians access a common ledger for ID sharing and provide federation between domains.

For reference, referring to an exemplary diagram of a service model providing federation between domains according to another embodiment of the present invention in FIG. 6, when an agreement is reached between the custodians 140a and 140b belonging to each domain (Domain A, Domain B) and the ledger for ID sharing 180 is built with distributed ledger technology of a common protocol so that only custodians can access it, ID federation between domains is possible.

In the case of federation of IDs between domains without a ledger for ID sharing, it is necessary to configure a complicated procedure that requires all federations for each domain. However, since the present invention can provide ID federation between domains through a ledger for ID sharing, this problem can be solved, and as the number of domains that can be linked increases, the holders can conveniently enjoy a wide range of services.

The digital ID storage and federation service model according to the present invention described above may be a countermeasure to overcome the limitations of the existing model, and it is possible to see an analysis result that it can be solved in terms of insufficient protection and convenience of holders (users) in Table 1 below.

TABLE 1

| Proposed | Constraints of Previous Model | | | | |
|---|---|---|---|---|---|
| Model | CT1 | CT2 | CT3 | CT4 | CT5 |
| Custody | ○ | ○ | ○ | ○ | |
| Model | | | | | |
| Federated | | | | | ○ |
| Model | | | | | |

When a digital ID issued by the issuer is not placed in a mobile device of the holder, but placed in a system of a custodian that meets security requirements, information leakage due to hacking or loss of the mobile device can be prevented. In addition, the safe storage service model by the custodian can safely conduct ID transactions even when the holder uses any terminal other than a mobile device.

In addition, even when the mobile device is lost or all digital IDs should be revoked or reissued, if the personal authentication procedure is safely performed through the custodian 140, the holder's inconvenience is greatly reduced. Above all, even when a decentralized ID service model is created individually in multiple domains, the holder 120 can safely receive more diverse services by establishing a storage and federation service model based on distributed ledger technology.

In addition, when the model of the present invention satisfies the above-mentioned security requirements, it is possible to appropriately respond to security threats. Table 2 below shows that the security requirements presented for the security threats of the model of the present invention are controllable.

TABLE 2

| Security | Security Threats | | | | | |
|---|---|---|---|---|---|---|
| Requirements | ST1 | ST2 | ST3 | ST4 | ST5 | ST6 |
| Network | ○ | ○ | | ○ | | ○ |
| Separation | | | | | | |
| Malware | ○ | | ○ | | ○ | |
| Control | | | | | | |
| Data | ○ | ○ | | ○ | | |
| Encryption | | | | | | |
| Data | | | ○ | | | |
| Integrity | | | | | | |
| Crypto key | ○ | ○ | | ○ | ○ | |
| Control | | | | | | |
| Log | | | ○ | | | |
| Recording | | | | | | |
| Fraud | ○ | ○ | | | | ○ |
| Detection | | | | | | |

When the custodian system of the present invention is separated from the network through an access control system, it is possible to prevent external attacks and leakage of IDs by insiders as well as leakage of encryption keys and unauthorized access.

Through malicious code control, ID leakage, transaction details, and forgery and falsification of applications can be blocked. Data encryption can prevent ID leakage and encryption key leakage by external attacks and insiders. Data integrity prevents forgery and falsification of ID transaction details, and safely encrypts and decrypts all information during ID transactions through the generation and use of encryption keys to block ID leakage and encryption key leakage by external attacks and insiders and to prevent application forgery and falsification.

Through log recording and preservation, ID transaction details are safely stored, and through an abnormal transaction detection system, ID leakage by external attacks and unauthorized ID theft by insiders are prevented, and unauthorized access can be effectively controlled.

Additionally, looking closely at the structure of the basic model of the decentralized ID service, it can be seen that it is similar to the PKI-based authentication system.

In other words, the e-wallet that safely stores user identity information is similar to the NPKI folder that stores public certificates, and the block chain has the same concept as the role of a public certificate directory server in that it publishes the user's public key.

Since the two models are similar, the PKI-based authentication system (e.g., public certificate and private certificate) can be equally applied as the model of the present invention. However, in the case of an accredited certification system, there is RootCA that manages the CA (Certificate Authority) serving as an issuer, and information is registered through register authority (RA), not a CA to issue a public certificate, and issuance is performed as an agency, so the hassle of issuing and renewing certificates for users still exits.

In Korea, public certificates are gradually disappearing due to the social atmosphere, and private certificates and decentralized ID technology are attracting attention as alternative means. Accordingly, if possible, it should be converted to a service model that safely stores and federate digital IDs.

The decentralized ID service model using distributed ledger technology has been studied and applied overseas, and as it is recognized as a promising business field in Korea, competition among various companies to preoccupy the business is intensifying.

However, since a common technical standard has not yet been fully developed, various companies or associations are developing technologies little by little without waiting for international or domestic standardization work. In this way, if each country, association, and domain implements with slightly different technologies and different service models, interoperability problems will surely come to the fore.

Since the emergence of various platforms using distributed ledger technology, it has been applied to various industries or companies in succession, but in the end, the reality that it is running individually here and there may be repeated as it is. If so, the holder may be able to find the sovereignty of his or her identity information, but will experience inconvenience in using the service due to the heterogeneous model. In addition, when the terminals that a holder can utilize are limited to mobile devices as of now, the holder vulnerable to mobile device security will experience difficulties in managing identity information due to information leakage or loss (theft) due to hacking.

In order to solve these problems, the present invention proposes a more improved digital ID storage and federation service by adding a separate secure custodian and auditor. In order to create an environment in which holders can use digital IDs more safely and conveniently while ensuring their sovereignty over data, the security of the custodian system and monitoring and auditing through the auditor must be strengthened.

In this respect, it may be necessary to develop cases and detection policies for abnormal transaction detection in more detail in the future.

In addition, in order to extend the model of the present invention to create a service that can federate between various domains, research on technology standards among associations or companies developing digital ID technologies and common protocols for applying them is also required.

Furthermore, the holder of digital ID is not limited to people, but it can also be applied to the Internet of Things (IoT), which collects various surrounding information. Information collected through numerous IoT devices (sensors) is supposed to be gathered to a central server without filtering for data processing. At this time, by grafting the concept of decentralized ID to IoT security, we expect that it will be extended to an invention that can be applied to IoT device management and data privacy protection by issuing a decentralized ID for each device and exercising sovereignty over the collected information.

Although the present invention has been described in detail with respect to the specific embodiments described above, it is obvious to those skilled in the art that various changes and modifications are possible within the scope of the technical idea of the present invention, and it is natural that such changes and modifications fall within the scope of the appended claims.

1. A digital ID storage and federation service model in which a custodian receives and safely stores identity information issued by a holder from an issuer and an auditor monitors ID transactions,
wherein the custodian creates a federation ID (F-ID) mapped to a digital ID received from the issuer, delivers it to the holder, stores it in a ledger for ID sharing, and records all ID transaction event history in a ledger for ID transaction, and
wherein when the holder submits the F-ID to a service provider while requesting the service from the service provider, the service provider requests verification from the custodian, and when the custodian delivers that verification is normally completed to the service provider, the service provider provides the requested service to the holder.

2. The digital ID storage and federation service model according to claim 1, wherein when the service provider requests verification, the custodian requests approval for verification from the holder, then performs a verification work only when there is approval of the holder, and records ID transaction event history in the ledger for ID transaction.

3. The digital ID storage and federation service model according to claim 2, wherein in the identify verification work of the custodian, a verifying agency who acts as an agency for a digital ID verification work of the holder is requested for verification in response to the request of the custodian, and the requested verifying agency performs a verification work such as whether the digital ID is authentic or not through a verification data storage, receives a verification result, and records ID transaction event history in the ledger for ID transaction.

4. The digital ID storage and federation service model according to claim 1, further comprising an auditor including a business operator or an institution that performs policy management, monitoring, and auditing of digital ID storage and transaction,
wherein the auditor detects and monitors abnormal transaction on all work history of transacting digital IDs for operating an abnormal transaction detection system.

5. The digital ID storage and federation service model according to claim 1, wherein the custodian includes individual custodians belonging to each domain, and a ledger for ID sharing is built with distributed ledger technology of common protocol to which the individual custodians are accessible, to operate to enable ID federation between domains.
